(19) United States
(12) Patent Application Publication
(10) Pub. No.: US 2009/0091055 A1
(43) Pub. Date: Apr. 9, 2009

(54) METHOD AND APPARATUS FOR PRODUCING PIPES HAVING A TRANSVERSE PROFILE FROM THERMOPLASTIC MATERIAL

(76) Inventor: Ralph Peter Hegler, Bad Kissingen (DE)

Correspondence Address: Husch Blackwell Sanders, LLP;Husch Blackwell Sanders LLP Welsh & Katz, 120 S RIVERSIDE PLAZA, 22ND FLOOR, CHICAGO, IL, 60606, US

(21) Appl. No.: 12/233,537

(22) Filed: Sep. 18, 2008

(30) Foreign Application Priority Data
Oct. 5, 2007 (DE) 10 2007 047 662.2

(51) Int. Cl. B29C 47/00

(52) U.S. Cl. 264/209.2; 425/113

(57) ABSTRACT

In a method and an apparatus for producing pipes having a transverse profile from thermoplastic material, mold segment halves are used on a molding path and are circulated in pairs. A main conveying device is provided for returning the mold segment halves, the main conveying device being designed like a gantry crane. A conveying bridge encompassing the molding path is provided with two conveying carriages which are displaceable at right angles to a direction of production and in opposite directions relative to each other and to which is in each case attached a downwards facing conveying arm comprising a holding device for in each case one mold segment half. Downstream of the downstream end of the molding path are provided parking positions for additional mold segment halves. Disposed downstream of the molding path is an auxiliary conveying device which is provided for removing the additional mold segment halves from the molding path in order to subsequently return them to the parking positions.

### BACKGROUND OF THE INVENTION

1. Field of the Invention

The invention relates to a method of producing pipes having a transverse profile from thermoplastic material by means of circulating mold segment halves which are arranged in two opposite rows downstream of an extrusion head and combine in pairs to form a closed hollow mold along a linear molding path,

wherein each of the unconnected mold segment halves of a row are guided out of the molding path at a downstream end in a direction substantially at right angles to a direction of production by means of a conveying device and are guided back to the upstream end of the molding path where they are re-fed into the molding path, and
wherein downstream of the downstream end of the molding path and on both sides thereof, a respective additional mold segment half is stored in a parking position, the additional mold segment half being feedable into the molding path by means of the conveying device.

Furthermore, the invention relates to an apparatus for producing pipes having a transverse profile.

2. Background Art

A method and an apparatus of this type are for example known from U.S. Pat. No. 5,693,347. By means of the conveying device, the respective mold segment halves used in the production of the corrugated pipe are removed from the molding path at the downstream end thereof and returned to the beginning of the molding path at the upstream end of the apparatus where they are fed back into the molding path. Each time a pipe form, in particular a socket, is to be produced which differs from the regular cross-section of a corrugated pipe, a pair of additional mold segment halves is additionally fed into the molding path from a parking position downstream of the molding path by means of the conveying device. After passing through the molding path, these additional mold segment halves are removed from the molding path by the conveying device and returned to the parking positions. Afterwards, the conveying device moves back to the downstream end of the molding path where it removes the next pair of mold segment halves in order to return them to the beginning of the molding path where they are fed into the molding path. The result of this embodiment was that the production speed of these apparatuses is limited.

### SUMMARY OF THE INVENTION

Thus it is the object of the invention to develop a method of the generic type such that the production speed can be increased, and to provide an apparatus for realization of the method.

In a method of the generic type, this object is attained in that the additional mold segment halves are removed from the molding path at the down-stream end by means of a auxiliary conveying device, which is separate from the conveying device acting as main conveying device, before being moved to the parking positions while a pair of mold segment halves, which is disposed directly upstream of the additional mold segment halves in the molding path when seen in the direction of production, is returned to the upstream end of the molding path where it is fed into the molding path.

Due to the fact that the removal of the additional mold segment halves from the molding path and their transport to their parking position is dispensed with, the entire production process, more specifically the extrusion rate and the speed of the mold segments on the molding path, can be increased considerably since the mold segment halves are moved opposite to the direction of production on a substantially straight line so that conveyance can take place at a very high speed.

In an apparatus of the generic type, this object is attained in that down-stream of the molding path, an auxiliary conveying device is provided for removing the additional mold segment halves from the molding path at the downstream end thereof and for moving these additional mold segment halves to their parking positions. The main conveying device and the auxiliary conveying device may be formed like a gantry crane.

Further features, advantages and details of the invention will become apparent from the description of an embodiment by means of the drawing.

### BRIEF DESCRIPTION OF THE DRAWINGS

FIG. 1 shows a plan view of an apparatus according to the invention for the production of pipes;

FIG. 2 shows a partially broken open front view of the apparatus according to the arrow II in FIG. 1;

FIGS. 3 to 7 show a plan view of the apparatus according to the invention in operating positions different from FIG. 1.

### DESCRIPTION OF THE PREFERRED EMBODIMENT

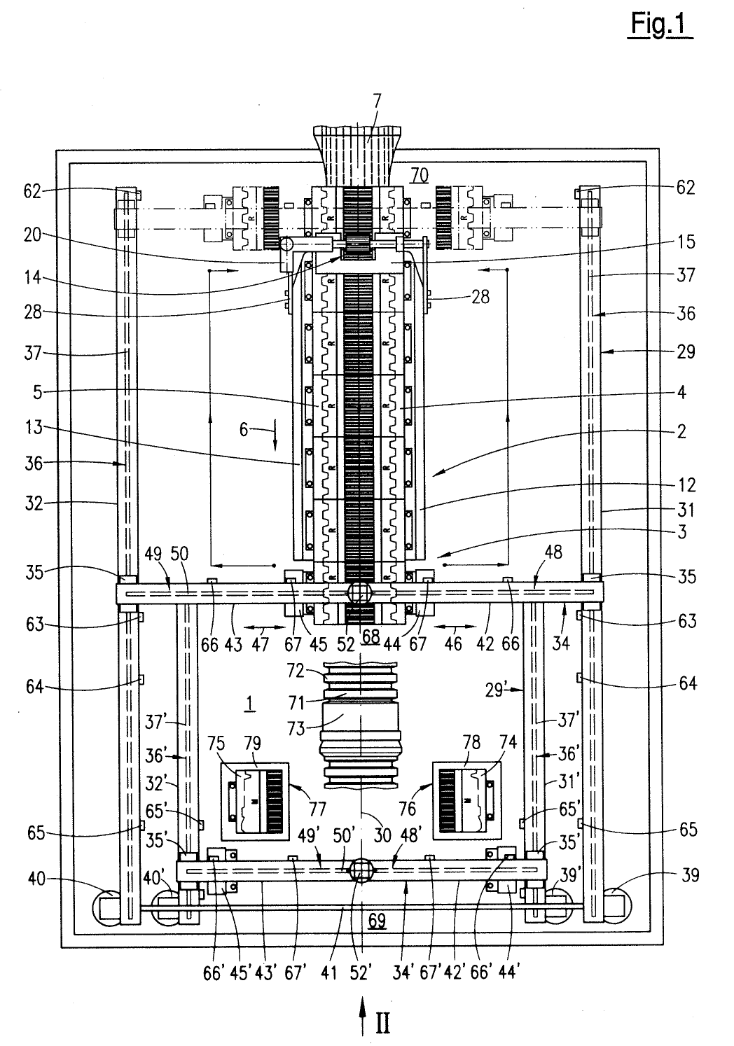

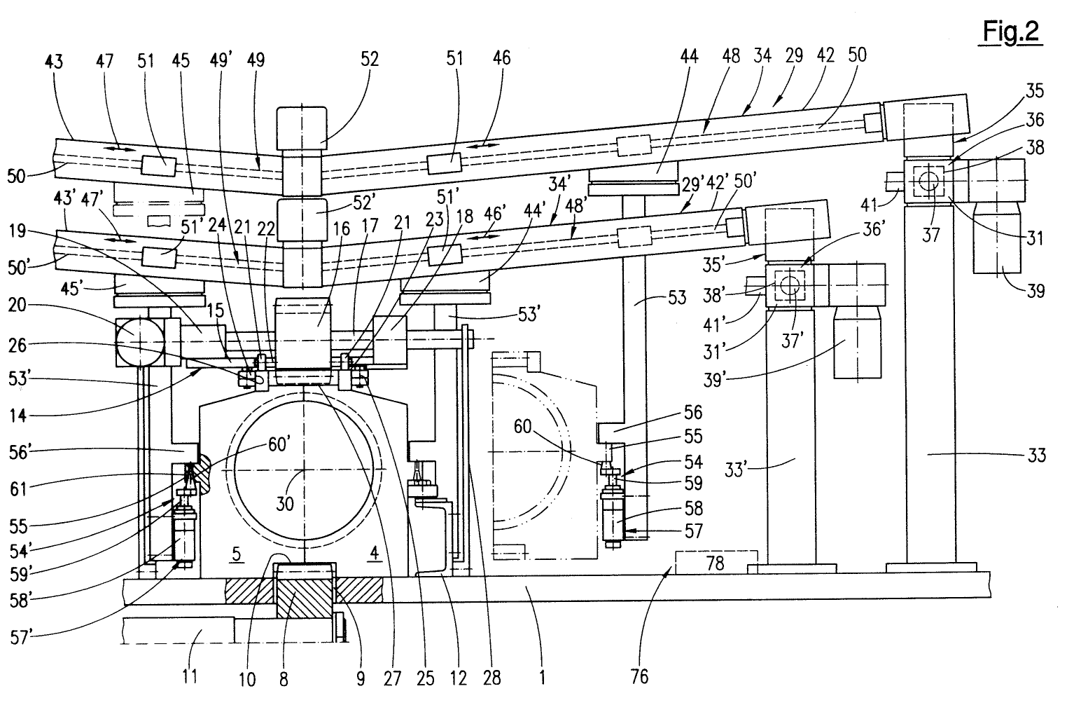

FIGS. 1 and 2 show an apparatus for producing pipes having a transverse profile from thermoplastic material. This apparatus has a base 1 with a molding path situated on it. On this molding path 2, mold segments 3 are lined up, each consisting of two mold segment halves 4, 5. As long as in each case two mold segment halves 4, 5 rest against each other to form a mold segment 3, and as long as adjacent mold segments 3 rest against each other to form a mold, they move in a straight line along the base 1 in a direction of production 6. For the continuous drive of the mold formed by the mold segments 3, a lower driving pinion 8 is provided right behind an extrusion head 7 of an extruder, the driving pinion 8 projecting out of a recess 9 in the base 1 and engaging with a tooth profile 10 formed on the respective lower side of the mold segment halves 4, 5. The lower driving pinion 8 is non-rotatably mounted on a drive shaft 11 which is located underneath the base 1 and driven by a gear motor not shown. The mold segment halves 4, 5 are in each case guided or held together, respectively, on the molding path 2 by guide rails 12, 13 which engage with the portion of the mold segment halves 4, 5 that is adjacent to the base 1.

A counterpart bearing 14 is provided above the base 1 and above the mold. It has a base plate 15 on which is supported an upper driving pinion 16. This upper driving pinion 16 is likewise non-rotatably mounted on a drive shaft 17, both ends of which are run in bearings 18, 19 which are fastened to the base plate 15. The drive shaft 17 is driven by a gear motor 20 which is attached to the adjacent bearing 19. Supporting rollers 21 are located on the lower side of the base plate 15, having a horizontal axis of rotation 22 and supporting themselves on supporting surfaces 23 formed on the upper side of each mold segment half 4, 5, which defines the position of the counterpart bearing 14 relative to the mold segment halves 4, 5. Guide rollers 24 are positioned on the lower side of the base plate 15, having a vertical axis of rotation 25 and engaging laterally with guide surfaces 26 that are also formed on the upper side of the mold segment halves 4, 5. By means of these guide rollers 24, two mold segment halves 4, 5 that constitute a mold segment 3 are guided and held together by their upper portion. Between the supporting surfaces 23 and the guide surfaces 26, respectively, the upper driving pinion 16 engages with an indentation 27, which is formed on the upper sides of the mold segment halves 4, 5. Only one third to one quarter of the amount of advance exercised on the mold segments 3 by the lower driving pinion 8 is transmitted to the mold segments 3 by the upper driving pinion 16. The counterpart bearing 14 is supported in torque converter bearings 28, which are mounted on the base 1 and stand vertically upright thereon and which absorb the torque exercised by the gear motor 20 on the counterpart bearing 14.

A main conveying device 29 for the mold segment halves 4, 5 is provided above the base plate 1. This main conveying device 29 is designed in the way of a gantry crane. It has two guide rails 31, 32 extending parallel to each other and parallel to the direction of conveyance 6, to the central longitudinal axis 30 of the mold segments 3 and to the base 1. These guide rails 31, 32 are disposed above the counterpart bearing 14 and supported relative to the base 1 by props 33. A conveying bridge 34 is supported on the guide rails 31, 32 by bogie wagons 35. Displacement of the conveying bridge 34 on the guide rails 31, 32 takes place by means of linear drives 36, which are spindle drives in the concrete embodiment. Consequently, these linear drives 36 have threaded spindles 37, which are disposed on the guide rails 31, 32 and on which are disposed threaded nuts 38 which are again fixed to the bogie wagons 35. The threaded spindles 37 are driven each by a gear motor 39, 40, these two gear motors 39, 40 being forcibly synchronized by way of a horizontal coupling shaft 41 that extends at right angles to the guide rails 31, 32. These two threaded spindles 37 are driven precisely at the same speed so that the conveying bridge 34 is displaced free from tilting on the guide rails 31, 32. The conveying bridge 34 has two bridge sections 42, 43, which, seen from the guide rails 31, 32, run toward each other, inclining toward the base 1. Consequently, the lowest distance of the bridge 34 from the base 1 is in the middle of the bridge 34 vertically above the central longitudinal axis 30. A conveying carriage 44, 45 is displaceably disposed on each of the two bridge sections 42, 43 and is movable in the respective direction of displacement 46 or 47 by means of a linear drive 48 or 49. These linear drives 48, 49 substantially consist of a threaded spindle 50 that is housed in the respective bridge section 42 or 43 and engages with a threaded nut 51 on the respective conveying carriage 44 or 45. The two threaded spindles 50 are driven by a common gear motor 52. The gear motors 39, 40 and the gear motor 52 are reversible motors, i.e. they are suitable for forward and reverse motion.

A conveying arm 53, which extends vertically downwards, is attached to each conveying carriage 44, 45. Each conveying arm 53 is provided with a holding device 54 for a mold segment half 4 and 5, respectively. Allocated to the holding device 54, a holding abutment 55 is formed on each mold segment half 4 and 5, respectively. Each holding device 54 has an upper stop 56 which a holding abutment 55 is pressed against from below. Further, a clamping device 57, which substantially consists of a pneumatic or hydraulic piston-cylinder drive 58, belongs to the holding device 54. A locking pin 60 is formed on the piston rod 59 of this drive 58, which, upon corresponding actuation of the drive 58, engages with a locking recess 61 on the lower side of the holding abutment 55, simultaneously pressing the abutment 55 against the stop 56. In the position shown on the left of FIG. 2, the holding device 54 and the holding abutment 55 of the adjacent mold segment half 4 or 5 are tightly interlocked; consequently, the latter is tightly united with the conveying arm 53.

Proximity switches—only some proximity switches 62, 63, 64, 65 of which are shown—are disposed on the guide rails 31, 32 and, upon approach of the conveying bridge 34, transmit signals reflecting the position thereof to a central control unit (not shown). Proximity switches 66, 67 are also provided on the conveying bridge 34, transmitting signals to the central control unit that reflect an inner or outer position of the respective conveying carriage 44, 45.

Apart from the main conveying device 29, an auxiliary conveying device 29′ is provided which is designed like the main conveying device 29 with the difference that the guide rails 31′, 32′ thereof, which are arranged between the guide rails 31, 32, only extend from the downstream end 68 of the molding path to the end 69 of the apparatus which is disposed even further down the line when seen in the direction of production 6. Since the design otherwise corresponds to that of the main conveying device 29, all equal or similar parts are denoted by reference numerals which are identical to those of the main conveying device 29 but are marked with an apostrophe. Therefore, reference can be made to the entire preceding description. Also shown in FIG. 1, the conveying bridge 34′ of the auxiliary conveying device 29′ is arranged downstream of the conveying bridge 34 of the main conveying device 29 when seen in the direction of production 6.

Two tubes of thermally plastic material are extruded from the extrusion head 7 of the extruder, entering the mold at the upstream end 70 of the molding path 2 where they are molded, by means of overpressure or vacuum and, if necessary, support air, into a compound pipe 71 which has a smooth inside wall and an outer corrugation 72, as known in detail from EP 0 563 575 A1 (corresponding to U.S. Pat. No. 5,320,797) which reference is made to. By alternative, it is also possible to mold single-piece corrugated pipes or ribbed pipes.

If a profile differing from the corrugation 72, for instance a socket 73, is to be produced on the pipe 71 at in each case longer intervals, a pair of special mold segment halves, for instance a pair of socket mold segment halves 74, 75, needs to be fed into the molding path 2. These mold segment halves 74, 75 are stored in parking positions 76, 77 which are formed by pedestals 78, 79 on which these mold segment halves 74, 75 are placed when they are not involved in the pipe molding process. These parking positions 76, 77 are adjacent to the end 69 of the apparatus. The auxiliary conveying device 29′ serves to return these mold segment halves 74, 75 from the downstream end 68 of the molding path 2 to their parking positions 76, 77.

The mold consisting of the mold segments 3 advances in the direction of production 6. The pipe 71 produced therein migrates at the same rate. When a mold segment 3 has reached the downstream end 68 of the molding path 2, the two mold segment halves 4, 5 that constitute this mold segment 3 must be removed from the molding path 2 crosswise of the direction of production 6. As shown in FIG. 1, this is done by the transverse conveying means formed by the conveying carriages 44, 45 with conveying arms 53. The conveying bridge 34 has moved ahead of the last mold segment 3 in the direction of production 6. As soon as this last mold segment 3 has reached the downstream end 68 of the molding path, the holding devices 54 and the holding abutments 55 of the two mold segment halves 4, 5 have been interlocked. In this mutually adjacent position, the conveying carriages 44, 45 were brought to a stop by way of the proximity switches 67. Afterwards, the conveying bridge 34, together with the mold segments 3 forming the mold, moves in the direction of production 6 at the same rate, wherein the two conveying carriages 44, 45, together with the mold segment halves 4, 5 with which they are interlocked, are moved away from one another. This movement is triggered by respective actuation of the gear motor 52 by way of a respective signal of the proximity switch 63. When this happens, the mold segment halves have already traveled in the down-stream direction, in other words beyond the guide rails 12, 13. Owing to the inclination of the two bridge sections 42, 43, the mold segment halves 4, 5 held by the conveying arms 53 are lifted off the base 1 and moved outwards without friction. When the conveying carriages 44, 45 reach the outer proximity switches 66, they are stopped. The gear motors 39, 40 are triggered so that the conveying bridge 34 is moved counter to the direction of production 6 as far as to the upstream end 67 of the molding path 2. Also during their transport counter to the direction of production 6, the mold segment halves 4, 5 do not contact the base 1, but are frictionless thereabove. They are always moved parallel to themselves.

When the upstream proximity switches 62 are reached, the gear motors 39, 40 are stopped so that the conveying bridge 34 is at a standstill. The gear motor 52 is switched on, moving the conveying carriages 44, 45 inwards toward the molding path and leads, at the upstream end, the two mold segment halves 4, 5 crosswise of the direction of production 6 into the molding path 2, as shown by dashed lines in FIG. 1. Upon displacement of the conveying carriages 44, 45 toward the molding path 2, owing to the inclination of the bridge sections 42, 43, the mold segment halves 4, 5 are again lowered toward the base 1, on which they rest when the two mold segment halves 4, 5 of a mold segment 3 contact, as seen in FIG. 2. Then the conveying bridge 34 is moved in the direction of production 6 until the two mold segment halves 4, 5 that already form a mold segment 3 bear against the mold segment halves 4, 5 that lead in the direction of production 6 and are seized and moved on by the driving pinions 8 and 16. Then the clamping devices 57 are released and the conveying arms 53 are again moved outwards away from the molding path 2. The conveying bridge 34 is then again displaced as far as to the downstream end 69, as described above.

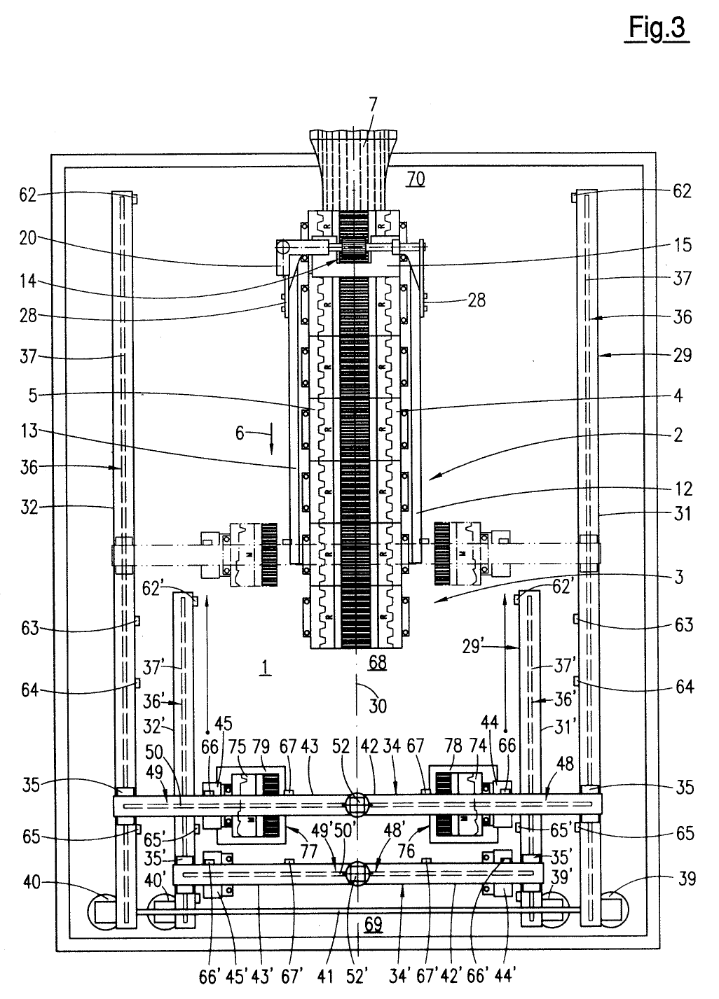

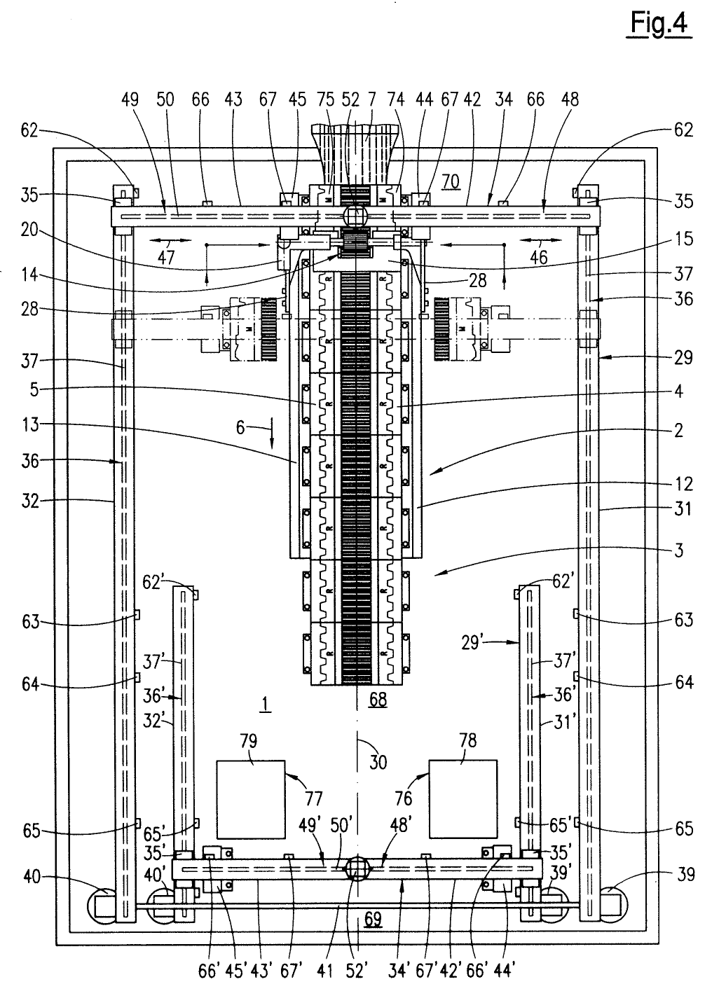

If it is desired to form a socket 73 in the continuous pipe 71, the main conveying device 29 is moved into the position shown by a dash-dot line according to FIG. 3 in which it is able to take up the socket mold segment halves 74, 75 from their parking positions 76, 77. As shown by the drawing, these parking positions 76, 77 are disposed between the guide rails 31′, 32′ of the auxiliary conveying device 29′. The longitudinal movement of the main conveying device 29 towards the end 69 of the apparatus is stopped by way of the proximity switches 65. Taking up the socket mold segment halves 74, 75 is performed in the same manner as described above with respect to the mold segment halves 4, 5. Afterwards, the socket mold segment halves 74, 75 are moved beyond the position shown dashed in FIG. 3 and the intermediate position shown dashed in FIG. 4 to the end position at the upstream end 70. Said end position of the main conveying device 29 is shown by a solid line in FIG. 4. The socket mold segment halves 74, 75 are fed into the molding path 2 in the manner described above.

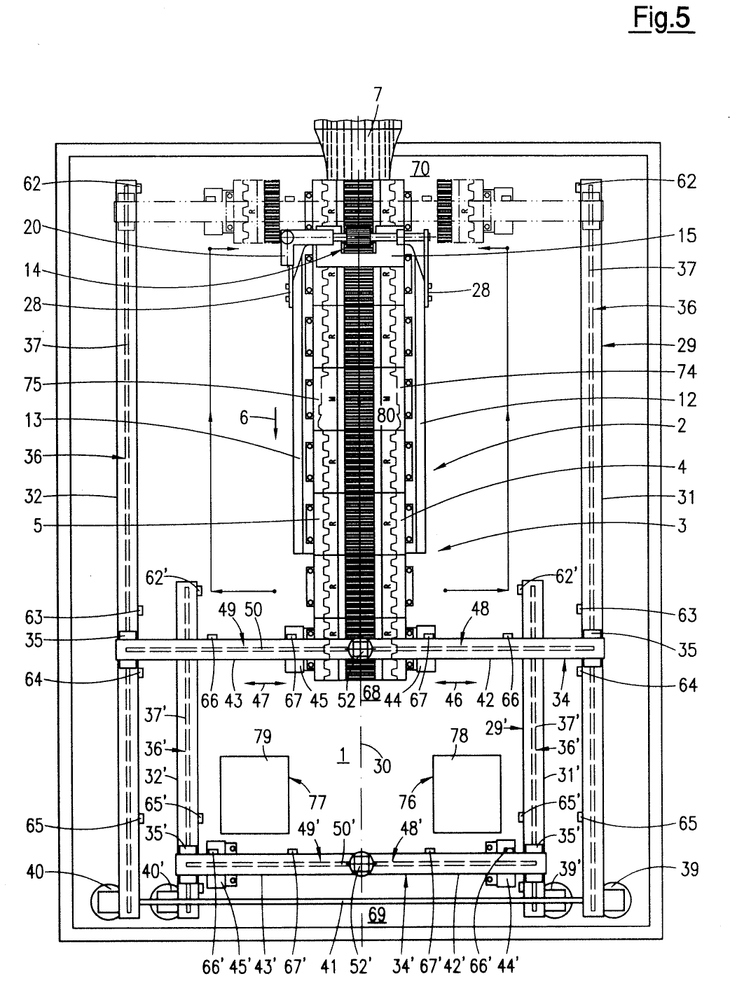

As shown by FIG. 5, the socket mold segment 80 formed by the socket mold segment halves 74, 75 travels downstream in the direction of production 6 along the molding path 2 to the downstream end 68. As shown by FIGS. 4 and 5 as well, there is now an additional mold segment 80 in the molding path 2 since none of the pairs of mold segment halves 4, 5 was removed from the production when the additional mold segment halves 74, 75 were fed in. While the socket mold segment 80 is still being moved along the molding path 2 in the direction of production 6, a respective pair of mold segment halves 4, 5 is removed at the downstream end 68 and returned to the upstream end 70 where it is fed into the molding path 2. This continues until the last pair of mold segment halves 4, 5 disposed upstream of the socket mold segment halves 74, 75 when seen in the direction of production 6 has been removed from the still extended molding path 2 and returned to the upstream end 70 where it is fed into the molding path 2. As shown by FIGS. 1 and 3 to 6, the auxiliary conveying bridge 34′ is until this moment located between the parking positions 76, 77 and the end 69 of the apparatus and does therefore never collide with the main conveying bridge 34, not even when taking up the socket mold segment halves 74, 75.

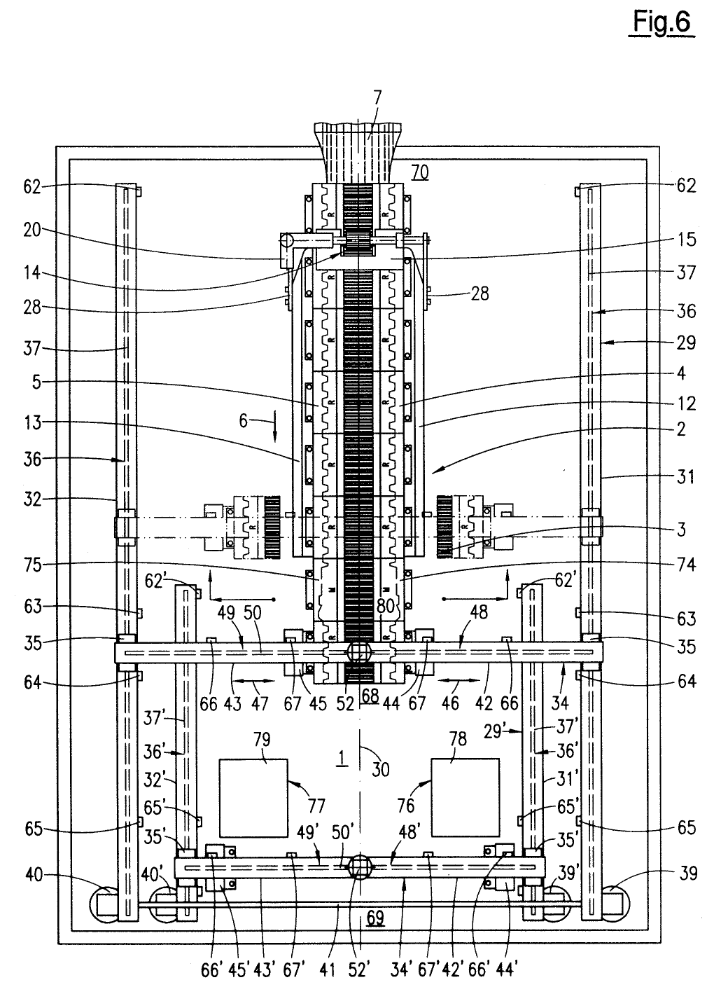

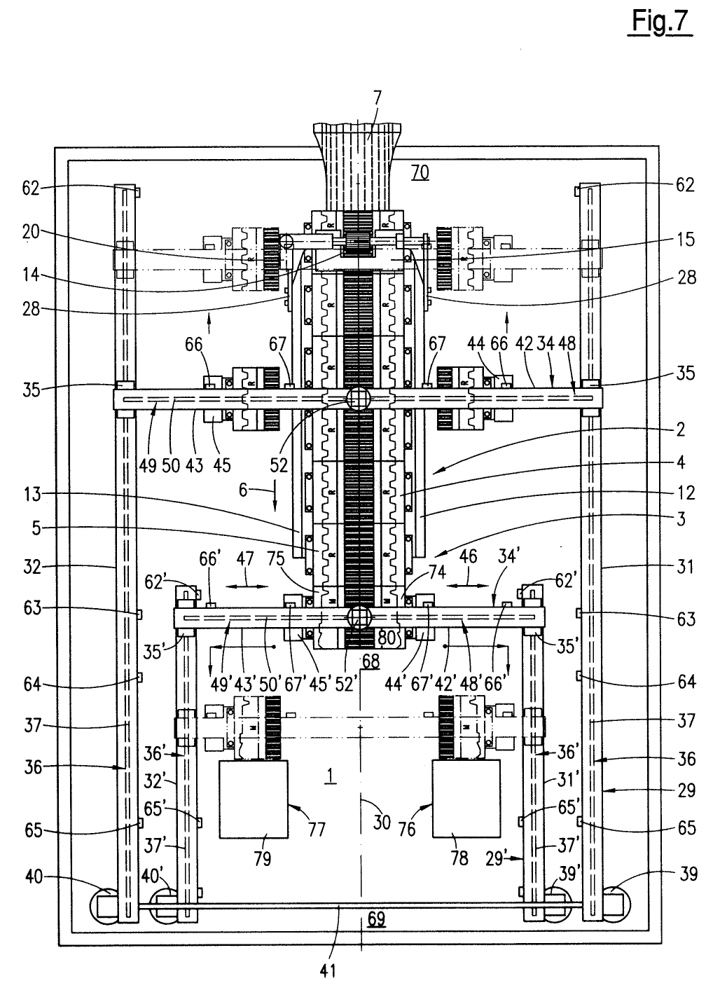

While the last pair of mold segment halves 4, 5, which—according to FIGS. 6 and 7—had been disposed upstream of the socket mold segment halves 74, 75 in the direction of production 6, is still being returned to the upstream end 70 of the molding path 2, the auxiliary conveying device 29′ is set in motion so as to move to the downstream end 68 where it is stopped by respective signals of the proximity switches 62′. The conveying carriages 44′, 45′ are moved inwards towards each other until they are stopped by way of proximity switches 67′, and the conveying arms 53′ and the socket mold segment halves 74, 75 are interlocked. The conveying carriages 44′, 45′ are then moved outwards until they are stopped by the proximity switches 66′. Afterwards, the auxiliary conveying device 29′ is returned to the parking positions 76, 77 in the direction of production 6 where the socket mold segment halves 74, 75 are placed on the pedestals 78, 79. The auxiliary conveying device 29′ is stopped at the parking positions 76, 77 by way of proximity switches 65′. The entire process takes place simultaneously with the return of the last mold segment halves 4, 5, which move upstream of the socket mold segment halves 74, 75, to the upstream end 70 and the feeding into the molding path 2. Thus, no additional time is required for removing and conveying the socket mold segment halves 74, 75 away from the molding path 2.

What is claimed is:

1. A method of producing pipes (71) having a transverse profile from thermoplastic material by means of circulating mold segment halves (4, 5) which are arranged in two opposite rows downstream of an extrusion head (7) and combine in pairs to form a closed hollow mold along a linear molding path (2),
wherein each of the unconnected mold segment halves (4, 5) of a row are guided out of the molding path (2) at a downstream end (68) in a direction substantially at right angles to a direction of production (6) by means of a conveying device (29) and are guided back to the upstream end (70) of the molding path (2) where they are re-fed into the molding path (2),
wherein downstream of the downstream end (68) of the molding path (2) and on both sides thereof, a respective additional mold segment half (74, 75) is stored in a parking position (76, 77), the additional mold segment half (74, 75) being feedable into the molding path (2) by means of the conveying device (29), and
wherein the additional mold segment halves (74, 75) are removed from the molding path (2) at the downstream end (68) by means of a auxiliary conveying device (29′), which is separate from the conveying device acting as main conveying device (29), before being moved to the parking positions (76, 77) while a pair of mold segment halves (4, 5), which is disposed directly upstream of the additional mold segment halves (74, 75) in the molding path (2) when seen in the direction of production (6), is returned to the upstream end (70) of the molding path (2) where it is fed into the molding path (2).

2. A method according to claim 1,
wherein socket mold segment halves (74, 75) are used as additional mold segment halves.

3. An apparatus for producing pipes having a transverse profile from thermoplastic material by means of circulating mold segment halves (4, 5) which are arranged in two opposite rows downstream of an extrusion head (7) and combine in pairs to form a closed hollow mold along a linear molding path (2),
wherein each of the unconnected mold segment halves (4, 5) of a row are guided out of the molding path (2) at a downstream end (68) in a direction substantially at right angles to a direction of production (6) by means of a conveying device (29) and are guided back to the upstream end (70) of the molding path (2) where they are re-fed into the molding path (2),
wherein downstream of the downstream end (68) of the molding path (2) and on both sides thereof, a respective additional mold segment half (74, 75) is stored in a parking position (76, 77), the additional mold segment half (74, 75) being feedable into the molding path (2) by means of the conveying device (29), and
wherein downstream of the molding path (2) is provided an auxiliary conveying device (29′) for removing the additional mold segment halves (74, 75) from the molding path (2) at the downstream end (68) thereof and for moving these additional mold segment halves (74, 75) to their parking positions (76, 77).

4. An apparatus according to claim 3,
wherein the main conveying device (29) is formed like a gantry crane which comprises a first conveying bridge (34) that is displaceable parallel to the direction of production (6) and encompasses the molding path (2); two first conveying carriages (44, 45) that are arranged on the first conveying bridge (34) and are displaceable at right angles to the direction of production (6) and in opposite directions relative to each other, and a first conveying arm (53) on each first conveying carriage (44, 45), wherein the first conveying arm (53) comprises a first holding device (54) for in each case one mold segment half (4, 5) and faces downwards towards the base plate (1).

5. An apparatus according to claim 4,
wherein the auxiliary conveying device (29′) is formed like a gantry crane which comprises a second conveying bridge (34′) that is displaceable parallel to the direction of production (6) and encompasses the molding path (2); two second conveying carriages (44′, 45′) that are arranged on the second conveying bridge (34′) and are displaceable at right angles to the direction of production (6) and in opposite directions relative to each other; and a second conveying arm (53′) on each second conveying carriage (44′, 45′), wherein the conveying arm (53) comprises a second holding device (54′) for in each case one additional mold segment half (74, 75) and faces downwards towards the base plate (1).
